(19) United States
(12) Patent Application Publication
(10) Pub. No.: US 2012/0326351 A1
(43) Pub. Date: Dec. 27, 2012

(54) Method of reconstructing rubber from crumb rubber and making composite materials therefrom

(75) Inventors: Dale Ryan, Green Core Springs, FL (US); John T. Preston, Hingham, MA (US)

(73) Assignee: Vantem Composite Technologies, LLC.

(21) Appl. No.: 13/135,085

(22) Filed: Jun. 24, 2011

(51) Int. Cl. B29C 43/26; B29C 43/00

(52) U.S. Cl. 264/120; 264/128

(57) ABSTRACT

A method for reconstructing rubber from crumb rubber includes mixing the crumb rubber with a binder of either urethane or sodium silicate, applying pressure to the mixture until the crumb rubber is flowable and molding the flowable rubber.

### FIELD OF THE INVENTION

This invention relates to rubber that has been reconstructed from crumb rubber and more particularly to a process involving the application of high pressure steps in which the crumb rubber is compressed in the presence of a binder, with the resultant product being used for building materials and structural elements.

### BACKGROUND OF THE INVENTION

There have been many attempts to recycle rubber tires and the like by grinding up the tires into what is called crumb rubber. However the reconstituted product made from crumb rubber has not been satisfactory because its structural properties do not approximate natural or synthetic rubber. Thus prior attempts have failed to produce a satisfactory reconstituted rubber product.

As a result, reclaimed rubber has not been utilized in structural products such as tires, railroad ties, building panels and the like, and it was simply not considered for these applications.

As to railroad ties, utility poles or marine pilings or pallets, the dominant factor has been cost. Until a cost effective replacement for wood is available, wooden poles, pilings, pallets will remain to be the standard of the industry but one that is ecologically troublesome.

It is noted that in all of these applications pressure treated wood is utilized, with the wood impregnated with creosote or CCA which is a form of arsenic, copper, chromate arsenate, as well as ACQ. ACQ is a copper cordinary, with CCA usually being a penta-chloral phenol. The purpose of the impregnation of the wood is to keep insects from attacking the wood and to kill insects as well as preventing mold and fungus from destroying the wood. However, all of these chemicals leach out, with the leached out chemicals going into groundwater. The leaching problem is so severe that leaching of these chemicals is classified as a carcinogenic hazard. In particular, creosote which is the common impregnatable resin is particularly high in carcinogenic chemicals.

Note that when one sees green utility poles or green plywood, the green color is a result of the CCA arsenic which is particularly environmentally toxic. It is so toxic that when using a skill saw respirators are required. In terms of utility poles and railroad ties alone, there are two billion pounds of preservative utilized, worth 6.2 billion dollars. Because this 2 billion pounds of preservative leaches into the soil, its use is completely banned in 26 countries other than the United States.

In terms of substituting plastics for these wooden building materials, cost is a prohibitive factor. Because the cost of plastic follows the cost of crude oil, as the crude oil price goes up so does that of plastics.

There is another problem with the use of plastics and that is the strength and longevity of plastics. As to structural strength of the plastics, typically polyethylene is an extremely weak material. It is very soft and has a relatively high coefficient of thermal expansion which must be kept under control. Thus the use of polyethylene as a building or structural material has been limited. Moreover, even if the polyethylene is reinforced, it is barely equal to wood, even though its use provides an adequately good defense against insects and degradation due to mold or mildew.

Thus in terms of strength, plastics cannot provide the properties which make wood so attractive. For instance as to plastic lumber utilized for decks, the plastic lumber is not considered structural. This is because its very rubbery flexible nature requires a massive substructure underneath, usually made out of the ecologically-challenged impregnated wood.

Aside from plastics, utility poles, railroad ties and the like have been made of concrete. However, the cost is usually prohibitive, as is the typical weight of the concrete column or railroad tie. For instance a typical railroad tie weighs about 220 pounds, whereas a concrete railroad tie weighs between 700 and 900 pounds. Moreover, the concrete is susceptible to the elements. Even with steel rebar reinforcement, the reinforced concrete when placed in a wet environment results in water working its way through to rust the rebar. Moreover, the water expands inside the concrete and cracks the concrete tie.

Additionally, with wood, plastic or concrete it is very difficult to control the modulus of elasticity of the structural product. For instance wood elasticity depends on the species and the way that the wood is cut. This cannot be changed and since its composition cannot be manipulated, elasticity can not be controlled. Thus, the modulus of elasticity (MOE) cannot be altered to for instance provide a soft riding railroad tie.

With respect to building panels, one can obviously vary the density of the core material and obtain different properties for wood-faced panels. Building panels are more or less monolithic in structure so that as long as one has obtained good performance and load carrying capability, then appropriately priced wood-based building panels can be manufactured.

All of the above described structural elements are rubber-free. Were it possible to utilize a molded rubber product reconstituted from crumb rubber, one could achieve inexpensive insect and weathering resistance while at the same time being able to vary the modulus of elasticity of the structural element.

By way of further background, in order to reinforce non-wood building elements such as railroad ties, utility poles and the like made of plastics, it might be thought desirable to reinforce the plastic with bamboo. In the past bamboo fiber which is for instance 20% stronger than steel, pound-for-pound, has been embedded in polyethylene plastic to provide a structural article. However, the problems with the utilization of bamboo fiber in such plastics are that the plastic manufacturing process is dependent upon heat for melting the plastic, typically 350°-400° Fahrenheit. When the plastic is melted if one introduces bamboo one almost certainly has at least a tiny percentage of moisture. It is noted that moisture and plastics do not go together. This is because moisture creates steam during the heating of the plastic. Thus, when trying to manufacture building or structural elements out of polyethylene and reinforcing it with bamboo, not only is the structural integrity in question due to the uncontrolled moisture content and the required heat, one is also faced with the rising cost of polyethylene itself.

It is noted that the moisture content in bamboo is around 9% where the bamboo is strongest. More moisture and strength drops off If one attempts to dry the bamboo to reduce moisture content to less than 9%, the resulting reinforced plastic article exhibits undesirable properties.

Note there are 1,330 varieties of bamboo and there are 25 to 30 types of bamboo referred to as timber bamboo. The timber bamboos are the ones that have exceptional strength, noting that the majority of the other bamboos are really no more than grasses. Moreover, the majority of bamboos are short, maybe 3 feet tall, whereas the 25 to 30 timber bamboos can grow to 110 to 120 feet high.

It will be appreciated that bamboo is typically very good at pulling silicates out of the soil, with the silicates giving bamboo its strength. If one cuts a tube of bamboo utilizing for instance a skill saw, one can actually see sparks fly off the saw due to the toughness of the bamboo. Moreover, bamboo grows in linear bundles which are nearly perfect bundles. Thus one could take a 40 foot tube of bamboo and split it at one end and the split would go all the way down to the other end perfectly lined up. There are those who refer to bamboo as nature's composite, and bamboo has been compared very favorably to Kevlar and carbon fiber.

In short, using bamboo as a strengthening agent for plastics has not proved successful. There is therefore a need for an inexpensive eco-friendly, insect and weather resistant molded structural member.

### SUMMARY OF INVENTION

It has now been found that crumb rubber can be reconstituted into moldable high quality rubber utilizing a high pressure process in which the crumb rubber is made to flow into a mold. This reconstituted rubber product can then be molded into a wide variety of products including structural elements. Since the final molded products are made from inexpensive crumb rubber, the resultant molded product is likewise inexpensive. The final rubber product is insect and weather resistant. Moreover, the molded product can incorporate reinforcing members or fillers to even further reduce the cost of the final product. Such reinforcing elements and fillers include polymer based elements such as polystyrene strapping materials as well as bamboo and rice hulls.

It has been found that one can reduce the amount of crumb required by adding fillers such as rice hulls at loadings up to 80% rice hulls to reduce overall cost without sacrificing structural performance.

### DETAILED DESCRIPTION

As part of the reconstitution the crumb rubber is compressed at high pressure at the presence of a specialized urethane, sodium silicate or other acceptable glues. In one embodiment, the applied pressure is stepped until the crumb rubber is flowable by first applying 1600 PSI and then in 15 second intervals stepping up the pressure by 500 PSI until the pressure reaches 3600 PSI.

The utilization of rubber, whether or not reinforced with bamboo or other additives, provides an exceptionally good insect repellant and weather resistant material that can be used in fence posts, railroad ties, telephone poles and indeed in building panels, with the modulus of elasticity being particularly well controlled. Gone is the requirement for caustic preservatives and with the utilization of crumb rubber, the cost of the building or structural elements well below wood structures.

While plastics have been investigated in the past, the question is to whether one could find a rubber substitute for plastic that was inexpensive enough to provide structural materials with the required properties. It was found that one could take crumb rubber and certain binder chemicals to produce a resin that one could mold with or without reinforcing materials or fillers to provide the required ecologically-friendly strong building component.

While it was theoretically possible to mix crumb rubber with epoxies and polyesters, the expense is prohibitive.

Crumb rubber on the other hand has the ability to last 100 years under ultraviolet light, has the ability to take shock and impact and its low present cost of 8 cents a pound is an attractive starting point. What is then required is a perfect resin matrix material. Note previously in the processing of crumb rubber, the crumb particles were forced together at only 40 PSI and in order to make them adhere one had to use a large amount of glue or adhesive.

On the other hand, it was found that the amount of glue or adhesive could be reduced to less than 10% by weight of the total article as long as one uses a specially-tailored urethane or sodium silicate binders and as long as one boosts the pressure above 1600 PSI where the crumb rubber was found to change state to a flowable plastic state. Specifically it was found that the crumb rubber turned into a flowable product that can be molded into a tire, with the resultant molded tire having properties that almost exactly duplicate a tire made of natural and synthetic rubber. This is confirmed when providing a transverse cut through the tire.

It is noted that in the subject process of providing reconstituted rubber, one does not add heat. The practically zero energy usage to make the molded parts makes the process exceedingly cost effective as it operates in an ambient temperature cure cycle.

As compared to wood railroad ties, for instance, the most expensive parts of making a wooden railroad tie are the extruders and extruder lines which operate at very high temperatures that require the raw material to be heated and then cooled.

Moreover, hard woods are very difficult to impregnate with creosote and the like such as CCA or penta because these materials do not penetrate into hard wood such as oak. If one wishes to increase the penetration, on might seek to use a soft wood such as pine. However pine is too soft for railroad tie applications.

As mentioned before, creosote use was the only cost effective way of making railroad ties, poles and the like insect and weather resistant. Note that for creosote the railroad tie is placed in a large metal tank and a vacuum is drawn on the wood after which the creosote is injected to penetrate the wood fibers.

On the other hand, in the subject invention crumb rubber is not only ecologically-friendly but also is resistant to environmental degradation from moisture, hot and cold cycling and insect infestation.

Crumb rubber is usually retrieved from recycled tires that are ground up to about the size of a lump of coal. Thereafter these nuggets are ground down to about walnut size, with further grinding techniques bringing the walnut size bits of rubber down to mesh sizes from a −10 mesh size to a −40 mesh size.

While it is possible to grind the rubber down to a −300 mesh size, it is more expensive to provide such fine particles.

With respect to tires such as truck tires, earth mover tires or passenger car tires, the percentage of natural rubber is usually high as compared to any synthetic rubber utilized for the tire. While the actual ratio of natural rubber to synthetic rubber varies from tire to tire, it has been found not to be a critical issue with the subject reconstituted rubber.

In terms of structural elements provided by the reconstituted rubber process described herein, the final reinforced product is made in one embodiment through a composite process, for instance involving a reinforcing fiber that basically carries the load, with the resin matrix maintaining alignment and for instance an isotropic high pressure that maintains all components locked in space. If non-flammable rice hulls are used as an extremely inexpensive filler, the interlocked rice hulls also add structural rigidity to the molded product while at the same time being fire resistant. In addition, polystyrene straps can be inserted into the rubber matrix to provide excellent reinforcement properties.

As will be described the use of a particular type and formulation of urethane such as available under the trade names Jowat and Gorilla Glue, have certain ratios of isocyanates and pre-polymers to the mixture. It has been found that most urethanes do not work well with crumb rubber as binders. However, the Jowat and Gorilla Glue ethylenes work precisely because of the high isocyanates to pre-polymer ratio in the mixture.

Note with the subject process that the reconstituted rubber may be molded to any arbitrary shape.

Moreover, unlike polyethylene by itself, the crumb rubber matrix can be utilized with a variant of the adhesive system to be able to bond the crumb rubber together so that for instance one can bond brackets to the crumb rubber molded piece.

Note that in one embodiment the adhesive or glue mixed with the crumb rubber is predominantly a urethane system with a high isocyanate content. With numerous isocyanate sites there are a multiplicity tenacious bonding sites, with urethanes in general being known for the ability to bond to cellulosics and other substrates.

In terms of for instance railroad ties, one would blend the crumb rubber with 1 to 2% of the binder chemical in for instance a high sheer or high intensity mixer, with the crumb rubber and its other constituents deposited for instance at the bottom of a mold.

Thereafter, in one embodiment in which the molded product is to be reinforced, layers of bamboo alternating with the layers of crumb rubber are placed one on top of the other such that the alternating layers of crumb rubber, binder mix and layers of unidirectional bamboo fiber are subjected to the +1600 PSI pressures. The amount of pressure for instance provided by a press can be applied for 10 to 15 second intervals for pressures starting at for instance 1600 PSI, and going to 2100 PSI, 2600 PSI and finally to 3100 PSI. Similar performance has been achieved using sodium silicate binders.

Note in one embodiment there is a 42 minute cure time involved, although this can be dramatically reduced with the addition of certain chemical additives.

It will be appreciated that the curing process involved with the reconstituted crumb rubber offers a major advantage because the molded material cures in the presence of moisture during the curing process in which the moisture is the catalyst that initiates the cure. This is useful in terms of the introduction of bamboo because in the crumb rubber process there is inherently enough moisture from the bamboo to initiate cure. If there is not enough moisture, in general adding a few drops of water is effective, since typical urethane cure cycles involve the water molecule as the catalyst.

Note in the curing process the urethane molecules form long chain molecules which cross link and produce the cure.

As to the weight of the final product, railroad ties usually weigh about 220 pounds per tie and with 4 cubic feet of material in a railroad tie one is looking at 50 to 55 pounds per cubic foot of density.

In terms of the particular stepped pressurized treatment in the mold it has been found that if one closes the mold and increases pressure in increments of 500 PSI, what happens is that the crumb rubber starts to enter a kind of plastic state and starts to flow around itself or any other reinforcing materials such as bamboo sticks. If one gives the rubber a little time to flow under one pressure, then the next increase in pressure is more effective to complete the flow. By giving the resultant composite a little bit more time to flow, one can bring the press down harder to another increase of 500 pounds per square inch.

It has been found in one embodiment that when one starts for instance at 500 PSI and goes up to 2000 PSI then the cure time is about 42 minutes.

Rather than using bamboo as a filler, in one embodiment of the subject invention rice hulls are preferred, for instance for structural panels. Additionally polystyrene straps can be used for structural enhancement.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. The method of reconstituting rubber from crumb rubber comprising the steps of:
mixing crumb rubber with a binder including one of urethane or sodium silicate; and
applying pressure to the mixture until the crumb rubber is flowable, molding the flowable rubber.

2. The method of claim 1, wherein the molded product is a composite.

3. The method of claim 1, wherein the pressure applied to the crumb rubber is stepped.

4. The method of claim 3, wherein the stepped pressure applied starts at a low pressure and then is stepped in intervals to until the pressure reaches a maximum pressure.

5. The method of claim 4, wherein the initial pressure exceeds 1600 psi.

6. The method of claim 4, wherein the stepping interval includes a stepping interval that exceeds 15 seconds.

7. The method of claim 6, wherein the pressure stepped is 500 psi.

8. The method of claim 7, wherein the pressure steps are terminated when the pressure reaches the maximum pressure.

9. The method of claim 8, wherein the maximum pressure reaches between 1600 pse and 3600 psi.

10. The method of claim 1, wherein and further including the step of adding fillers to the mixture.

11. The method of claim 10, wherein the fillers include polymer elements.

12. The method of claim 11, wherein the polymer elements include polystyrene elements.

13. The method of claim 12, wherein the fillers include natural fiber elements.

14. The method of claim 13, wherein the natural fiber elements include bamboo.

15. The method of claim 13, wherein the natural fiber elements include rice hulls.

16. The method of claim 15, wherein the natural fiber loading is between 10 and 90% of the total weight.
